(19) United States
(12) Patent Application Publication
(10) Pub. No.: US 2017/0235165 A1
(43) Pub. Date: Aug. 17, 2017

(54) OPTICAL DEVICE

(71) Applicant: PANASONIC INTELLECTUAL PROPERTY MANAGEMENT CO., LTD., Osaka (JP)

(72) Inventors: Tomonori YAMADA, Tokyo (JP); Yuko SUZUKA, Osaka (JP)

(73) Assignee: PANASONIC INTELLECTUAL PROPERTY MANAGEMENT CO., LTD., Osaka (JP)

(21) Appl. No.: 15/503,540

(22) PCT Filed: Dec. 15, 2015
(86) PCT No.: PCT/JP2015/006240

§ 371 Date: Feb. 13, 2017

(30) Foreign Application Priority Data
Dec. 24, 2014 (JP) 2014-260771

(51) Int. Cl. G02F 1/137; G02F 1/15; G02F 1/1343

(52) U.S. Cl. CPC G02F 1/137; G02F 1/13439; G02F 1/1525; G02F 2201/44; G02F 2001/1515; G02F 2001/13756; G02F 2203/09; G02F 2203/03

(57) ABSTRACT

An optical device includes a first electrode and a second electrode that have translucency and are disposed facing each other, and an optical adjustment layer that is disposed between the first electrode and the second electrode. The optical adjustment layer includes a first phase that includes an electrolyte including a metal having a visible light reflecting property, and a second phase that is dispersed in the first phase, and includes a variable refractive index material having a refractive index that is variable in a visible light range.

### TECHNICAL FIELD

The present invention relates to an optical device.

### BACKGROUND ART

Conventionally, optical devices have been developed in which optical states such as light transmission and reflection can be varied according to power supply conditions. For example, Patent Literature (PTL) 1 discloses a light adjusting element including an electrolyte layer sandwiched between a pair of electrodes. The electrolyte layer in the light adjusting element includes an electrochromic material containing silver ions. By adjusting a voltage to be applied across the pair of electrodes, the light adjusting element is allowed to achieve a light transmission state and a specular state.

### CITATION LIST

### Patent Literature

PTL 1: WO 2012/118188

### SUMMARY OF THE INVENTION

### Technical Problem

However, although the above-noted light adjusting element described in PTL 1 can achieve the specular state, it cannot achieve a light scattering state.

With the foregoing in mind, it is an object of the present invention to provide an optical device capable of maintaining three optical states of reflection, transmission, and scattering.

### Solution to Problem

In order to achieve the object mentioned above, an optical device according to one aspect of the present invention includes a first electrode and a second electrode that have translucency and are disposed facing each other, and an optical adjustment layer that is disposed between the first electrode and the second electrode. The optical adjustment layer includes a first phase that includes an electrolyte including a metal having a visible light reflecting property, and a second phase that is dispersed in the first phase, and includes a variable refractive index material having a refractive index that is variable in a visible light range.

### Advantageous Effects of Invention

In accordance with the present invention, it is possible to provide an optical device capable of maintaining three optical states of reflection, transmission, and scattering.

### BRIEF DESCRIPTION OF DRAWINGS

FIG. 1 schematically illustrates cross sections of an optical device according to an embodiment of the present invention.

FIG. 2A illustrates an optical state when a DC voltage is applied to the optical device according to an embodiment of the present invention.

FIG. 2B schematically illustrates a light reflection state of the optical device according to an embodiment of the present invention.

FIG. 3A illustrates an optical state when an AC voltage is applied to the optical device according to an embodiment of the present invention.

FIG. 3B schematically illustrates a light transmission state of the optical device according to an embodiment of the present invention.

FIG. 4A illustrates an optical state when no voltage is applied to the optical device according to an embodiment of the present invention.

FIG. 4B schematically illustrates a light scattering state of the optical device according to an embodiment of the present invention.

FIG. 5 is a state transition diagram of optical states of the optical device according to an embodiment of the present invention.

FIG. 6 is a sectional view illustrating a double glazing unit including the optical device according to an embodiment of the present invention.

### DESCRIPTION OF EXEMPLARY EMBODIMENT

In the following, an optical device according to an embodiment of the present invention will be detailed, with reference to the accompanying drawings. It should be noted that each embodiment described below illustrates one specific preferred example of the present invention. Thus, the numerical values, shapes, materials, structural components, the arrangement and connection of the structural components mentioned in the following embodiment are merely an example and not intended to limit the present invention. Accordingly, among the structural components in the following embodiment, the one that is not recited in any independent claim exhibiting the most generic concept of the present invention will be described as an arbitrary structural component.

Also, each of the figures is a schematic view and not necessarily illustrated in a strict manner. Moreover, in each of the figures, the same structural members are assigned the same reference signs.

### EMBODIMENT

[Outline of Optical Device]

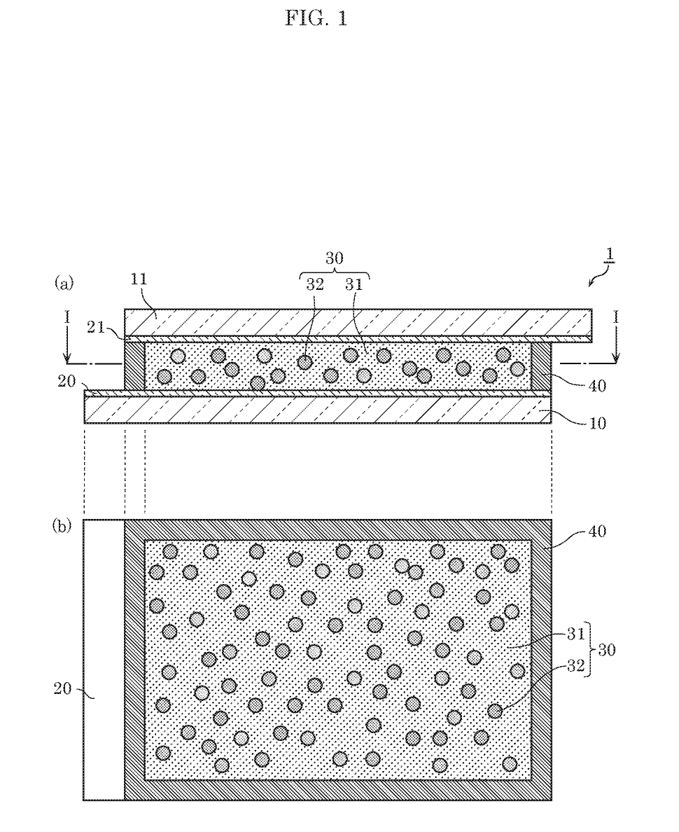

First, the outline of the optical device according to the present embodiment will be described with reference to FIG. 1. FIG. 1 schematically illustrates cross sections of optical device 1 according to the present embodiment. More specifically, (a) of FIG. 1 schematically illustrates a layered structure of optical device 1. Furthermore, (b) of FIG. 1 illustrates a cross section taken along line I-I in (a).

As illustrated in FIG. 1, optical device 1 includes first substrate 10, second substrate 11, first electrode 20, second electrode 21, optical adjustment layer 30, and sealing material 40. Moreover, as illustrated in (b) of FIG. 1, optical device 1 is formed into a panel shape.

According to power applied across first electrode 20 and second electrode 21 of optical device 1, it is possible to switch among three optical states, namely, a light reflection state, a light transmission state, and a light scattering state.

More specifically, in the light reflection state, optical device 1 reflects incident light (for example, visible light). It is noted that the reflection is specular reflection, for example, but may also be scatter reflection. Optical device 1 in the light reflection state has a light transmittance of about 0, for example.

Furthermore, in the light transmission state, optical device 1 transmits incident light (for example, visible light). For example, optical device 1 can achieve a transparent state.

Moreover, in the light scattering state, optical device 1 scatters incident light (for example, visible light). More specifically, optical device 1 in the light scattering state transmits part of visible light and scatters part of the visible light owing to a difference in refractive index within optical adjustment layer 30.

The following is a detailed description of each of structural components included in optical device 1, with reference to FIG. 1.

[Substrates]

First substrate 10 and second substrate 11 have translucency, and transmit at least part of the visible light. More specifically, first substrate 10 and second substrate 11 are flat plates that are transparent (have a sufficiently high light transmittance).

As illustrated in FIG. 1, first substrate 10 and second substrate 11 are disposed in such a manner as to face each other. More specifically, first substrate 10 and second substrate 11 are disposed such that a distance between first substrate 10 and second substrate 11 (a thickness of optical adjustment layer 30) is substantially constant. In other words, first substrate 10 and second substrate 11 are disposed in parallel with each other.

First substrate 10 and second substrate 11 have substantially the same shape and substantially the same size. More specifically, first substrate 10 and second substrate 11 are rectangular in plan view. Alternatively, first substrate 10 and second substrate 11 may have other polygonal shapes such as a square or any shapes such as a circle or an ellipse in plan view. It should be noted that the phrase “in plan view” refers to the case of viewing a principal surface (a surface having a maximum area) of each of first substrate 10 and second substrate 11 from a front side (namely, in a thickness direction of optical device 1).

In the present embodiment, as illustrated in FIG. 1, first substrate 10 and second substrate 11 are disposed such that end portions of first substrate 10 and second substrate 11 are displaced from each other. The end portions are outside portions that are not surrounded by sealing material 40, and correspond to, for example, feeder portions for first electrode 20 and second electrode 21, respectively. First substrate 10 and second substrate 11 are disposed in such a manner as to be displaced from each other, thereby allowing an easy line connection to the feeder portions, for example.

First substrate 10 and second substrate 11 are formed of the same material, for example. First substrate 10 and second substrate 11 can be, for example, a glass substrate made of soda glass, non-alkali glass or highly refractive glass, or a resin substrate made of polyethylene terephthalate (PET) or polyethylene naphthalate (PEN). The glass substrate has an advantage of having excellent transparency and moisture resistance. The resin substrate has an advantage of reduced shattering at the time of breakage. Moreover, first substrate 10 and second substrate 11 may be a flexible substrate that can be bent easily. The flexible substrate is formed of, for example, a resin substrate or a glass thin film.

[Electrodes]

First electrode 20 and second electrode 21 have translucency, and transmit at least part of the visible light. More specifically, first electrode 20 and second electrode 21 are transparent electrically-conductive films having a flat plate shape. When a predetermined voltage is applied across first electrode 20 and second electrode 21, an optical property of optical adjustment layer 30 changes.

As illustrated in FIG. 1, first electrode 20 and second electrode 21 are disposed in such a manner as to face each other. More specifically, first electrode 20 is formed on first substrate 10, and second electrode 21 is formed on second substrate 11. For example, first electrode 20 and second electrode 21 are formed by depositing electrically-conductive films on first substrate 10 and second substrate 11 respectively by sputtering, vapor deposition or the like, and patterning the deposited electrically-conductive films. At this time, first electrode 20 and second electrode 21 may be formed respectively on first substrate 10 and second substrate 11 via undercoating layers having translucency.

First electrode 20 is electrically connected to a feeder portion that is provided in the end portion of first substrate 10, specifically, provided outside sealing material 40. For example, the feeder portion is a portion of first electrode 20 and extends outside sealing material 40. The same applies to second electrode 21.

First electrode 20 and second electrode 21 are formed of the same material, for example. First electrode 20 and second electrode 21 can be formed of, for example, a transparent metal oxide such as indium tin oxide (ITO), indium zinc oxide (IZO), aluminum-doped zinc oxide (AZO) or fluorine-doped tin oxide (FTO).

It should be noted that each of first electrode 20 and second electrode 21 has a sheet resistance less than a predetermined value. For example, each of first electrode 20 and second electrode 21 has a sheet resistance of less than or equal to 100 Ω/sq. and preferably less than or equal to 10 Ω/sq. This makes it possible to enhance in-plane uniformity at the time of driving the device. Incidentally, an auxiliary electrode that has a lower sheet resistance may be provided in at least one of first electrode 20 and second electrode 21.

Furthermore, at least one of first electrode 20 and second electrode 21 may have a surface roughness. This makes it possible to scatter or distribute light.

Additionally, first electrode 20 and second electrode 21 are respectively formed of materials having a difference in refractive index in a visible light range smaller than a predetermined value with respect to first substrate 10 and second substrate 11. For example, the difference in refractive index between first electrode 20 and first substrate 10 is less than or equal to 0.2 and preferably less than or equal to 0.1. In this way, light reflection and refraction at an interface between first electrode 20 and first substrate 10 can be suppressed, thus allowing effective light transmission. The same applies to second electrode 21 and second substrate 11. Additionally, first electrode 20 and second electrode 21 may be formed of different materials. In this case, it is preferable that the difference in refractive index between the material for first electrode 20 and the material for second electrode 21 is also smaller than a predetermined value.

[Optical Adjustment Layer]

Optical adjustment layer 30 is disposed between first electrode 20 and second electrode 21. As illustrated in FIG. 1, optical adjustment layer 30 includes first phase 31 and second phase 32. In the present embodiment, optical adjustment layer 30 is gel.

According to a voltage applied across first electrode 20 and second electrode 21, it is possible to switch among the light reflection state, the light transmission state, and the light scattering state of optical adjustment layer 30. More specifically, first phase 31 and second phase 32 vary as in (1) to (3) below, whereby optical adjustment layer 30 achieves the three optical states.

(1) Light reflection: when metal in first phase 31 is deposited to form a metal film

(2) Light transmission (transparent): when metal in first phase 31 does not form a metal film and the refractive indices of first phase 31 and second phase 32 are substantially the same

(2) Light scattering: when metal in first phase 31 does not form a metal film and the refractive indices of first phase 31 and second phase 32 are different

In the following, first phase 31 and second phase 32 will be detailed.

First phase 31 includes an electrolyte that contains metal having a visible light reflecting property. In the present embodiment, first phase 31 further includes a polymeric material and a high boiling point solvent. More specifically, in first phase 31, the electrolyte is dissolved in a mixed solvent of the polymeric material and the high boiling point solvent.

The polymeric material included in first phase 31 can be, for example, polyvinyl alcohol (PVA), polyvinyl butyral (PVB), polymethyl methacrylate (PMMA), mercapto ester, cellulose, polyvinyl acetate, polystyrene (PS), poly(4-vinylpyridine) (P4VP), poly(dimethylaminoethyl methacrylate) (PDMAEMA), epoxy, or a silicone resin such as a modified silicone or dimethylpolysiloxane (PDMS).

First phase 31 may further include a cross-linking agent. In other words, the cross-linking agent may be used to form cross-links in the polymeric material. The cross-linking agent can be, for example, N,N,N′,N′-tetra(trifluoromethane sulfonyl)-hexane-1,6-diamine (C6TFSA), or N,N,N′,N′-tetra(trifluoromethane sulfonyl)-dodecane-1,2-diamine (C12TFSA).

Incidentally, studies by the inventors have shown that it is difficult to dissolve the electrolyte in the polymeric material alone. Accordingly, in the present embodiment, first phase 31 includes not only the polymeric material but also the high boiling point solvent. The high boiling point solvent can be a material having a relative dielectric constant greater than a predetermined value. For example, the relative dielectric constant of the high boiling point solvent is greater than or equal to 20 and preferably greater than or equal to 50. This allows the electrolyte to be dissolved easily.

Now, as described later, the use of optical device 1 for a window is conceivable. Thus, the window may be exposed to the sunlight and heated to a high temperature. Accordingly, in the present embodiment, the high boiling point solvent is used to suppress volatilization of the solvent, thereby enhancing reliability. For example, the boiling point of the high boiling point solvent is higher than or equal to 85° C. and preferably higher than or equal to 100° C. Furthermore, assuming the use in cold climates, it is preferable that the melting point of the high boiling point solvent is lower than or equal to −20° C.

For example, the high boiling point solvent can be dimethyl sulfoxide (DMSO), N-methyl-2-pyrrolidone (NMP), N,N-dimethylformamide (DMF), propylene carbonate (PC), ethylene carbonate (EC), acetonitrile, γ-butyrolactone (GBL), water, glycerin or the like, or a mixed material thereof.

When the polymeric material and the high boiling point solvent are mixed, the viscosity of the mixture (specifically, the viscosity of first phase 31) is set not to be extremely low or high. For example, when the viscosity of first phase 31 is too low, second phase 32 is not fixed and moves freely. In this case, a liquid crystal property of second phase 32 is lost, and refractive index variability of second phase 32 is impaired. On the other hand, when the viscosity of first phase 31 is too high, a conductivity of metal ions relating to the light reflection decreases, so that response characteristics of the light reflection are deteriorated.

Thus, the viscosity of first phase 31 (specifically, the viscosity of the mixture of the polymeric material and the high boiling point solvent) falls within a predetermined range. For example, the viscosity of first phase 31 ranges from 5000 cps to 1000000 cps and preferably from 10000 cps to 500000 cps. This makes it possible to fix second phase 32 and allows the metal ions in the electrolyte to be conducted. Incidentally, in the case where the polymeric material forms a polymer network, the resultant polymer network may have so fine a size (for example, on the order of several μm) that second phase 32 cannot be conducted.

The electrolyte is a chemical compound that generates predetermined metal ions by ionization. For example, the electrolyte can be silver nitrate, silver acetate or silver sulfate that generates silver ions, or copper chloride that generates copper ions.

The electrolyte has a concentration ranging from 10 mM to 5000 mM, for example. This makes it possible to achieve both the transmittance when the electrolyte is dissolved (at the time of transmission) and the reflectance when the metal is deposited (at the time of reflection). It should be noted that the concentration of the electrolyte is not particularly limited.

Furthermore, first phase 31 may further include a support electrolyte. This makes it possible to control a response speed. The support electrolyte can be, for example, tetrabutyl ammonium percolate, tetrabutyl ammonium bromide, or lithium bromide.

The thickness of first phase 31 (namely, the thickness of optical adjustment layer 30) ranges, for example, from 5 μm to 1 mm and preferably from 10 μm to 500 μm. This makes it possible to suppress a decrease in the transmittance and achieve a reduction of material costs. Additionally, it is possible to achieve a sufficient reflectance.

Second phase 32 is dispersed in first phase 31. In other words, second phase 32 corresponds to a dispersed phase, and first phase 31 corresponds to a dispersed medium. Second phase 32 includes a variable refractive index material whose refractive index is variable in a visible light range.

More specifically, the variable refractive index material is a liquid crystal. The liquid crystal can be, for example, a nematic liquid crystal, a cholesteric liquid crystal, or a ferroelectric liquid crystal. However, there is no particular limitation to the above. In the liquid crystal, changes in an electric field causes variations in molecular alignment, so that the refractive index of the liquid crystal is varied.

In the present embodiment, the liquid crystal included in second phase 32 is dispersed in the polymeric material included in first phase 31. In other words, optical adjustment layer 30 corresponds to a polymer dispersed liquid crystal (PDLC). It should be noted that optical adjustment layer 30 may be a polymer network liquid crystal (PNLC).

At this time, the relative dielectric constant of second phase 32 may be different from the relative dielectric constant of first phase 31. This makes it possible to prevent second phase 32 from being dissolved and mixed in first phase 31. For example, when the relative dielectric constant of first phase 31 is greater than or equal to 30 and preferably greater than or equal to 40, the relative dielectric constant of second phase 32 may be less than or equal to 20 and preferably less than or equal to 15. This achieves phase separation of first phase 31 and second phase 32.

Furthermore, in order to enhance effects of the phase separation, second phase 32 may be covered with a film-like substance or micelle. Alternatively, by mixing a silane coupling agent into first phase 31, second phase 32 may be chemically bonded to first electrode 20 or second electrode 21 via the silane coupling agent. More specifically, an Si—O bond of the silane coupling agent chemically bonded to a liquid crystal molecule is chemically bonded to ITO serving as an electrode material. In this manner, it is possible to suppress the dispersion of the liquid crystal molecule of second phase 32 into first phase 31.

Moreover, the specific gravity of second phase 32 may be substantially the same as the specific gravity of first phase 31. This makes it possible to suppress precipitation of either of first phase 31 and second phase 32. Additionally, the refractive index of first phase 31 may fall within a variable range of the refractive index of second phase 32. This makes it possible to achieve the same refractive index for first phase 31 and second phase 32, thereby allowing optical adjustment layer 30 to appear transparent.

Furthermore, there is no particular limitation to volume fractions of first phase 31 and second phase 32. For example, when a priority is given to the reflectance, the volume fraction of first phase 31 is raised. When a priority is given to the light scattering property (light distribution property), the volume fraction of second phase 32 is raised. It should be noted that, when the volume fraction of one of first phase 31 and second phase 32 is lower than 10%, sufficient reflecting and scattering properties may become unavailable. Thus, the substantial volume fraction of each of first phase 31 and second phase 32 ranges from 10% to 90%.

[Sealing Material]

Sealing material 40 is a member for allowing first substrate 10 and second substrate 11 to adhere to each other in order to hold optical adjustment layer 30 between first electrode 20 and second electrode 21. Sealing material 40 is formed into a predetermined shape along a periphery of optical adjustment layer 30.

Sealing material 40 can be formed of a photo-curing, thermosetting or two-part setting adhesive resin, for example, an epoxy resin, an acrylic resin or a silicone resin. Alternatively, sealing material 40 may be formed of a thermoplastic adhesive resin including an acid modified material such as polyethylene or polypropylene.

Incidentally, sealing material 40 may include granular spacers in order to secure the thickness of optical adjustment layer 30 (the distance between first electrode 20 and second electrode 21). The granular spacer may be, for example, glass beads, resin beads, or silica particles.

[Operation]

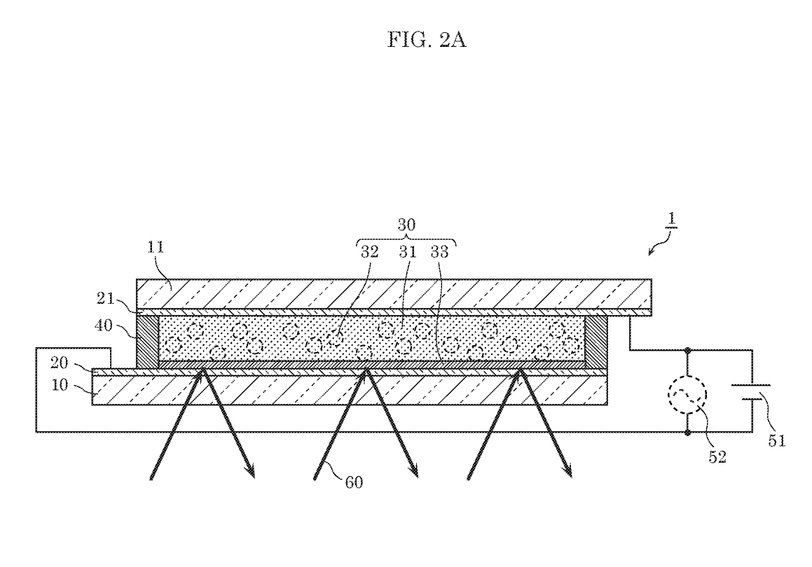

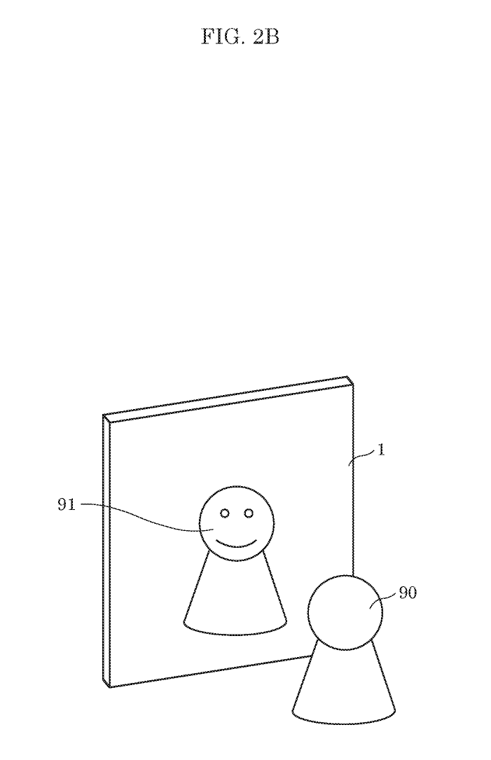

Next, the operation of optical device 1 according to the present embodiment will be described with reference to FIG. 2A to FIG. 4B. More specifically, each of the three possible optical states of optical device 1 will be described.

Light Reflection State

The light reflection state (light reflection mode) is one of the optical states of optical device 1 and a state (mode) in which visible light that reaches optical device 1 is reflected. More specifically, optical adjustment layer 30 has a light reflecting property. At this time, optical adjustment layer 30 may also have a light transmitting property and a light scattering property. In other words, the light reflection state refers to a state in which reflection of visible light is dominant compared with transmission and scattering of the visible light.

FIG. 2A illustrates an optical state when a DC voltage is applied to optical device 1 according to the present embodiment. FIG. 2B schematically illustrates the light reflection state of optical device 1 according to the present embodiment.

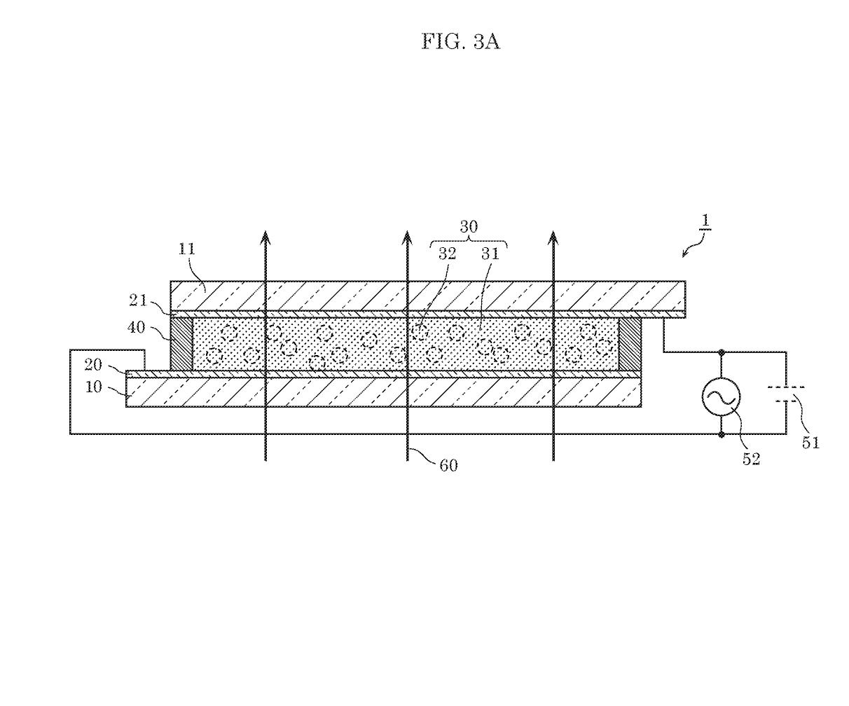

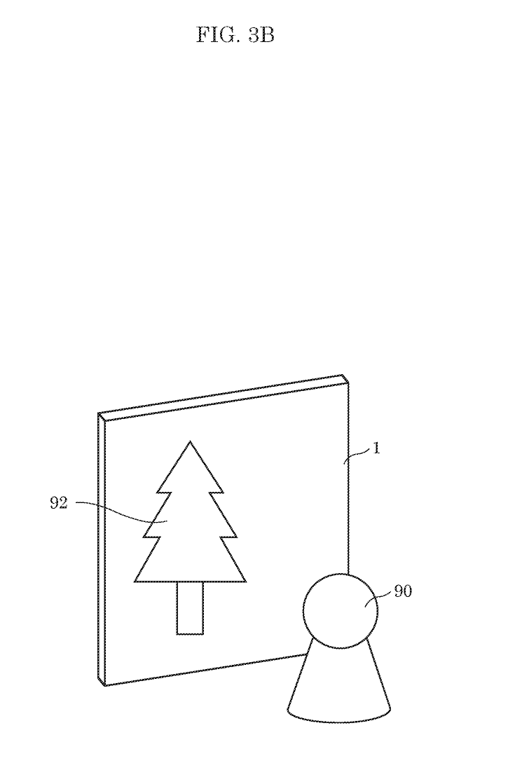

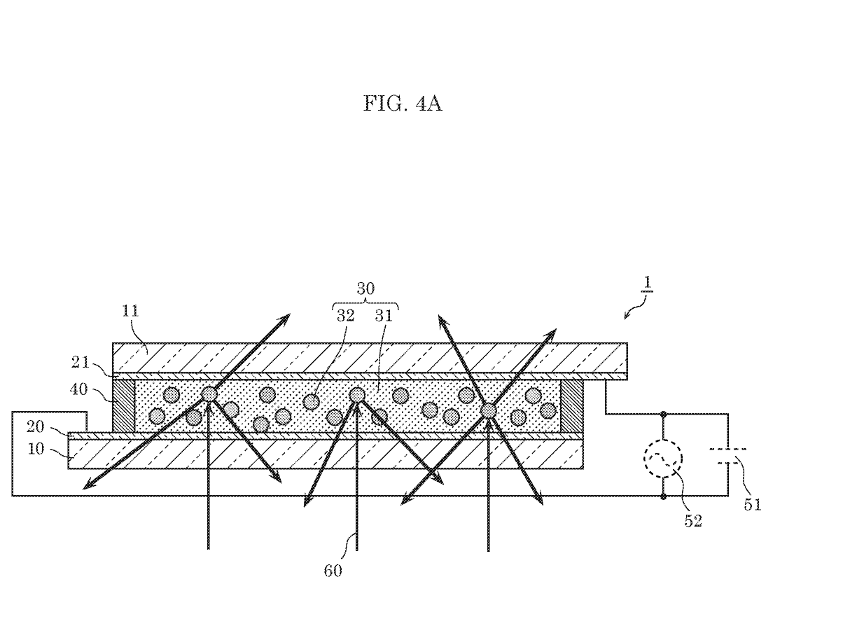

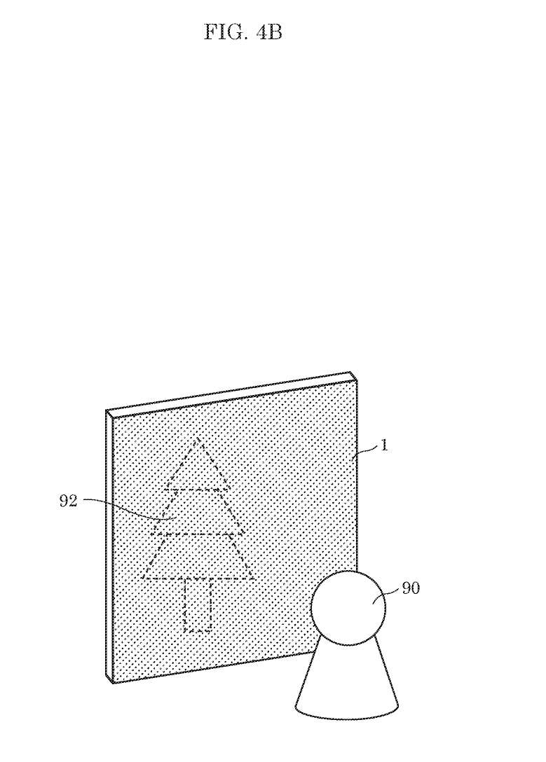

As illustrated in FIG. 2A, FIG. 3A, and FIG. 4A, DC power supply 51 and AC power supply 52 are connected between first electrode 20 and second electrode 21. For example, each of DC power supply 51 and AC power supply 52 is connected with a switch (not shown). By turning ON or OFF this switch, it is possible to apply the DC voltage or the AC voltage across first electrode 20 and second electrode 21.

It should be noted that optical device 1 may include a power supply circuit including DC power supply 51, AC power supply 52, and the switch. This power supply circuit may be detachable from optical device 1.

As illustrated in FIG. 2A, the DC voltage is applied across first electrode 20 and second electrode 21 by DC power supply 51. In this way, optical device 1 reflects visible light 60, thus achieving the light reflection state. The DC voltage may range, for example, from 2 V to 3 V. Incidentally, as an example, first electrode 20 is a negative electrode and second electrode 21 is a positive electrode in this figure. However, there is no particular limitation to this. First electrode 20 may be a positive electrode, and second electrode 21 may be a negative electrode.

Specifically, when the DC voltage is applied, at least part of metal contained in the electrolyte in first phase 31 is deposited on first electrode 20 and forms metal film 33. More specifically, since metal ions are cations, they are drawn to first electrode 20 serving as the negative electrode and move in first phase 31. Then, the metal ions receive electrons from first electrode 20, turn into metal atoms and adhere to first electrode 20, thus forming metal film 33. Because metal film 33 has a light reflecting property, it can reflect visible light 60.

In this manner, as illustrated in FIG. 2A, visible light 60 reaching optical device 1 from a side of first electrode 20 is reflected by metal film 33.

Incidentally, visible light reaching optical device 1 from a side of second electrode 21 passes through first phase 31 and second phase 32 before being reflected by metal film 33. Thus, this visible light is affected by a difference in transmitting property or scattering property caused by a difference in refractive index between first phase 31 and second phase 32.

For example, the refractive index of second phase 32 varies according to the voltage applied across first electrode 20 and second electrode 21. When the refractive index of second phase 32 is substantially equal to the refractive index of first phase 31, the visible light travels straight without being refracted by an interface between first phase 31 and second phase 32. Thus, in this case, the incident visible light from the side of second electrode 21 is directly transmitted by first phase 31 and second phase 32, reflected by metal film 33, transmitted again by and leaves first phase 31 and second phase 32.

When the refractive index of second phase 32 is different from the refractive index of first phase 31, the visible light is refracted by the interface between first phase 31 and second phase 32. Since second phase 32 is dispersed in first phase 31, the incident visible light from the side of second electrode 21 is refracted toward various directions and, as a result, reflected in a scattering manner.

Incidentally, although metal film 33 specularly reflects the visible light, for example, metal film 33 may also reflect the visible light in a scattering manner. For example, either of the specular reflection and the scatter reflection is achieved depending on a shape of metal film 33. For instance, when first electrode 20 has a flat surface, metal film 33 is formed also as a flat film, so that metal film 33 can specularly reflect the visible light. On the other hand, when first electrode 20 has a rough surface, metal film 33 is formed also as a rough film, so that metal film 33 can reflect the visible light in a scattering manner.

As described above, if optical device 1 is in the light reflection state, person 90 can view mirror image 91 of him/herself in optical device 1, for example, as illustrated in FIG. 2B. At this time, person 90 cannot view an object that is located across optical device 1 from person 90. For example, in the case where optical device 1 is used as a window, person 90 who is inside can view his/her own reflection but cannot view scenery outside the window.

Light Transmission (Transparent) State

The light transmission state (light transmission mode) is one of the optical states of optical device 1 and a state (mode) in which the visible light that reaches optical device 1 is transmitted. More specifically, optical adjustment layer 30 has a light transmitting property. At this time, optical adjustment layer 30 may also have a light reflecting property and a light scattering property. In other words, the light transmission state refers to a state in which transmission of visible light is dominant compared with reflection and scattering of the visible light (specifically, a transparent state).

FIG. 3A illustrates an optical state when an AC voltage is applied to optical device 1 according to the present embodiment. FIG. 3B schematically illustrates the light transmission state of optical device 1 according to the present embodiment.

As illustrated in FIG. 3A, the AC voltage is applied across first electrode 20 and second electrode 21 by AC power supply 52. In this way, optical device 1 transmits visible light 60, thus achieving the light transmission (transparent) state. The AC voltage may be, for example, 100 V.

More specifically, metal contained in the electrolyte in first phase 31 is deposited on neither first electrode 20 nor second electrode 21, does not form metal film 33, and is present as metal ions in first phase 31.

Furthermore, in second phase 32, the application of the AC voltage causes liquid crystal molecules to be aligned on average along a predetermined direction. Accordingly, the refractive index of second phase 32 becomes substantially equal to the refractive index of first phase 31. Since the difference in refractive index between second phase 32 and first phase 31 is substantially zero, the visible light is not refracted by the interface between second phase 32 and first phase 31 and travels straight. Thus, in this case, visible light 60 reaching optical adjustment layer 30 is transmitted directly.

As described above, when the AC voltage is applied across first electrode 20 and second electrode 21, the metal contained in the electrolyte does not form metal film 33, and the refractive index of second phase 32 is substantially equal to the refractive index of first phase 31. In this manner, visible light 60 passes through optical device 1, and optical device 1 is in the transparent state. Incidentally, if the refractive indices of optical adjustment layer 30, first electrode 20, second electrode 21, first substrate 10, and second substrate 11 at this time are substantially equal to one another, higher transparency can be achieved.

When optical device 1 is in the transparent state, person 90 can view object 92 through optical device 1 as illustrated in FIG. 3B, for example. Incidentally, person 90 and object 92 are located on either side of optical device 1. For example, in the case where optical device 1 is used as a window, person 90 who is inside can view outside scenery (object 92).

Light Scattering State

The light scattering state (light scattering mode) is one of the optical states of optical device 1 and a state (mode) in which the visible light that reaches optical device 1 is scattered. More specifically, optical adjustment layer 30 has a light scattering property. At this time, optical adjustment layer 30 may also have a light reflecting property and a light transmitting property. In other words, the light scattering state refers to a state in which scattering of visible light is dominant compared with reflection and transmission of the visible light.

FIG. 4A illustrates an optical state when no voltage is applied to optical device 1 according to the present embodiment. FIG. 4B schematically illustrates the light scattering state of optical device 1 according to the present embodiment.

As illustrated in FIG. 4A, no voltage is applied across first electrode 20 and second electrode 21. In this way, optical device 1 scatters visible light 60, thus achieving the light scattering state.

More specifically, metal contained in the electrolyte in first phase 31 is deposited on neither first electrode 20 nor second electrode 21, does not form metal film 33, and is present as metal ions in first phase 31.

Further, in second phase 32, liquid crystal molecules are arranged at random because no voltage is applied. Accordingly, the refractive index of second phase 32 is different from the refractive index of first phase 31. Thus, visible light 60 reaching optical adjustment layer 30 is refracted by the interface between first phase 31 and second phase 32. Since second phase 32 is dispersed in first phase 31, visible light 60 reaching optical adjustment layer 30 is refracted toward various directions and, as a result, scattered.

As described above, when no voltage is applied across first electrode 20 and second electrode 21, the metal contained in the electrolyte does not form metal film 33, and the refractive index of second phase 32 is different from the refractive index of first phase 31. In this manner, visible light 60 is scattered when passing through optical device 1, so that optical device 1 is in the light scattering state.

If optical device 1 is in the light scattering state, person 90 cannot view object 92 sharply through optical device 1, for example, as illustrated in FIG. 4B. For example, in the case where optical device 1 is used as a window, person 90 who is inside cannot view outside scenery (object 92) because optical device 1 functions as so-called frosted glass.

Switching Among Optical States (Modes)

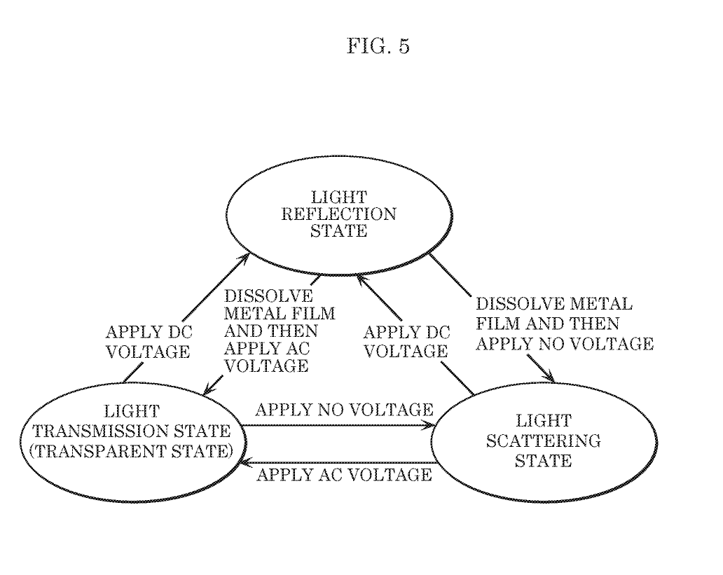

Now, switching among the optical states (modes) described above will be described with reference to FIG. 5. FIG. 5 is a state transition diagram of the optical states of optical device 1 according to the present embodiment.

As illustrated in FIG. 5, when optical device 1 is in the light reflection state, it is possible to make a change into the light transmission state by dissolving metal film 33 between first electrode 20 and second electrode 21 and then applying the AC voltage across first electrode 20 and second electrode 21. It should be noted that metal film 33 can be dissolved by, for example, stopping the application of the DC voltage or applying a DC reverse bias voltage. Conversely, when optical device 1 is in the light transmission state, it is possible to restore the light reflection state by applying the DC voltage across first electrode 20 and second electrode 21.

Furthermore, when optical device 1 is in the light transmission state, it is possible to make a change into the light scattering state by applying no AC voltage across first electrode 20 and second electrode 21. Conversely, when optical device 1 is in the light scattering state, it is possible to restore the light transmission state by applying the AC voltage across first electrode 20 and second electrode 21.

Moreover, when optical device 1 is in the light scattering state, it is possible to make a change into the light reflection state by applying the DC voltage across first electrode 20 and second electrode 21. Conversely when optical device 1 is in the light reflection state, it is possible to restore the light scattering state by dissolving metal film 33 into first phase 31 and then applying neither the DC voltage nor the AC voltage across first electrode 20 and second electrode 21. It should be noted that metal film 33 can be dissolved by, for example, stopping the application of the DC voltage or applying a DC reverse bias voltage.

### EXAMPLE

The following is a description of an example of optical device 1 according to the present embodiment. The inventors prepared a sample according to the example, and confirmed that this sample was able to achieve the three optical states described above.

First, an electrolyte was added to a high boiling point solvent, followed by stirring, thereby dissolving the electrolyte in the high boiling point solvent. As the high boiling point solvent, 10 mL of DMSO (special grade, produced by Wako Pure Chemical Industries, Ltd.) was used. Furthermore, as the electrolyte, 85 mg of silver nitrate (special grade, produced by Wako Pure Chemical Industries, Ltd.), 400 mg of tetrabutyl ammonium bromide, and 12 mg of copper chloride (II) (special grade, produced by Wako Pure Chemical Industries, Ltd.) were used.

Next, a variable refractive index material was added to the high boiling point solvent in which the electrolyte had been dissolved. Then, a polymeric material and a cross-linking agent were added, followed by stirring. As the variable refractive index material, 2 mL of mlc-2169 produced by Merck Ltd. was used. As the polymeric material, 1.5 g of P4VP (special grade, produced by Wako Pure Chemical Industries, Ltd.) was used. As the cross-linking agent, 0.5 g of C12TFSA (special grade, produced by Wako Pure Chemical Industries, Ltd.) was used. The stirring was performed at 80° C. for 30 minutes.

In this manner, a solution serving as a raw material of optical adjustment layer 30 was prepared.

On the other hand, two 3 cm×3 cm glass substrates were prepared as first substrate 10 and second substrate 11. Then, 90 nm thick ITO was deposited on a principal surface of each of the two glass substrates by magnetron sputtering, so that first electrode 20 and second electrode 21 were obtained.

Subsequently, the surfaces provided with ITO were placed to face each other using a spacer between first substrate 10 and second substrate 11 so as to form a 500 μm gap. More specifically, an ultraviolet curing epoxy resin containing Micropearl (produced by SEKISUI CHEMICAL CO., LTD.) (sealing material 40) was applied along a periphery of first substrate 10 and second substrate 11, thereby allowing first substrate 10 and second substrate 11 to adhere to each other.

Thereafter, the solution serving as the raw material of optical adjustment layer 30 was injected into the gap between first substrate 10 and second substrate 11. For example, an injection port was provided in a portion of the epoxy resin applied along the periphery, and the solution was injected through this injection port. For instance, the solution can be filled in the gap by immersing the injection port in the solution to allow the solution to be sucked up into the inner gap utilizing an osmotic pressure. Alternatively, before the two glass substrates were made to adhere to each other, the solution may be dropped to a region surrounded by the epoxy resin.

In this manner, it was possible to form optical adjustment layer 30 between first substrate 10 and second substrate 11. After optical adjustment layer 30 was formed, optical adjustment layer 30 was sealed by irradiating the epoxy resin with ultraviolet rays and curing the epoxy resin.

As described above, the sample of optical device 1 was produced. By applying the voltage as noted above, it was confirmed that the produced sample was able to achieve the three optical states of the light reflection state, the light transmission state, and the light scattering state.

[Double Glazing Unit]

Optical device 1 described above can be utilized, for example, for a window of a building or a vehicle. More specifically, optical device 1 is disposed in an internal portion of a double glazing unit including a pair of glass plates, whereby this double glazing unit can be utilized as the window.

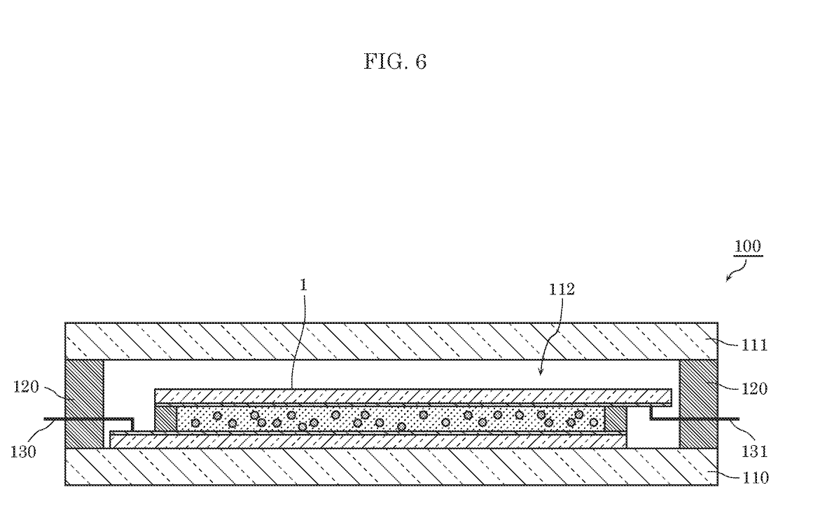

FIG. 6 is a sectional view illustrating double glazing unit 100 including optical device 1 according to the present embodiment.

As illustrated in FIG. 6, double glazing unit 100 according to the present embodiment includes optical device 1, a pair of glass plates 110 and 111, spacing material 120, electrode line 130, and electrode line 131. Furthermore, the pair of glass plates 110 and 111 and spacing material 120 define internal space 112. Moreover, internal space 112 is filled with, for example, a dry air or an inert gas.

The inert gas is a gas having a low reactivity for a chemical reaction or the like to other substances. For example, the inert gas may be a noble gas such as argon (Ar), helium (He), neon (Ne) or krypton (Kr), or nitrogen (N₂). It should be noted that internal space 112 may be decompressed to have a pressure lower than the atmospheric pressure or held at the atmospheric pressure.

Optical device 1 is disposed in internal space 112. Incidentally, internal space 112 may further include a light-emitting device such as an organic electroluminescent (EL) element, for example. This makes it possible to utilize double glazing unit 100 as, for example, a Smart window that is applicable to uses such as illumination, mirror, or information display.

In the following, each of structural components included in double glazing unit 100 will be detailed.

Glass plate 110 and glass plate 111 have translucency, and transmit at least part of visible light. Glass plates 110 and 111 are flat transparent plates formed of, for example, soda glass or non-alkali glass. As illustrated in FIG. 6, glass plates 110 and 111 are disposed in such a manner as to face each other. More specifically, glass plates 110 and 111 are disposed such that a distance between glass plates 110 and 111 (a thickness of internal space 112) is substantially constant. In other words, glass plates 110 and 111 are disposed in parallel with each other. The distance between glass plates 110 and 111 is, for example, 12 mm.

Furthermore, glass plates 110 and 111 have substantially the same shape and substantially the same size, and are disposed in such a manner as to overlap each other in plan view. It should be noted that the phrase “in plan view” refers to the case of viewing a principal surface (a surface having a maximum area) of each of glass plates 110 and 111 from a front side.

Spacing material 120 is disposed along a periphery of the pair of glass plates 110 and 111, and spaces glass plates 110 and 111 away from each other. More specifically, spacing material 120 is disposed between glass plate 110 and glass plate 111. For example, spacing material 120 is a substantially rectangular frame that extends along the periphery of glass plate 110.

Spacing material 120 includes a spacer and an adhesive, for example.

The spacer is a member that keeps a constant distance between glass plate 110 and glass plate 111. The spacer includes, for example, a hollow member made of aluminum and a granular substance filled in an internal portion of the hollow member. The hollow member is a substantially prismatic frame, for example. The granular substance can be a drying agent such as silica gel or zeolite, for example. This suppresses entry of water into internal space 112.

The adhesive allows the spacer to adhere to each of glass plates 110 and 111. The adhesive allows the spacer to adhere to glass plate 110 and to glass plate 111 such that no space is left between the spacer and glass plates 110 and 111. For example, the adhesive is formed by disposing glass plates 110 and 111 so as to sandwich the spacer and then injecting and curing an adhesive material between the spacer and each of glass plates 110 and 111.

The adhesive can be formed of a photo-curing, thermosetting or two-part setting adhesive resin, for example, an epoxy resin, an acrylic resin or a silicone resin. Alternatively, the adhesive may be formed of a thermoplastic adhesive resin including an acid modified material such as polyethylene or polypropylene.

Incidentally, spacing material 120 may be an adhesive including a granular spacer.

Electrode line 130 and electrode line 131 are wiring for supplying electric power to optical device 1. More specifically, electrode line 130 is wiring for supplying electric power to first electrode 20. Electrode line 131 is wiring for supplying electric power to second electrode 21. For example, electrode line 130 and electrode line 131 are connected to DC power supply 51 and AC power supply 52, and supply a DC voltage from DC power supply 51 and an AC voltage from AC power supply 52 to first electrode 20 and second electrode 21.

As illustrated in FIG. 6, electrode line 130 and electrode line 131 pass through spacing material 120, for example. In this figure, electrode line 130 and electrode line 131 pass through a central portion of spacing material 120. However, there is no particular limitation to this. For example, electrode line 130 and electrode line 131 may be provided along glass plate 110 and pass through a portion between spacing material 120 and glass plate 110. Electrode lines 130 and 131 are, for example, metal patterns made of silver or the like, or a lead wire.

As described above, the application of optical device 1 according to the present embodiment to the window produces various advantages.

For example, when optical device 1 is in the light transmission (transparent) state, a person inside (a resident or the like) can check an outdoor condition or a weather and appreciate an outside view. In this manner, optical device 1 can achieve a so-called “window” function.

Furthermore, when optical device 1 is in the light scattering state, dimming can be performed by adjusting a degree of scattering. In addition, since it is not possible to view the inside from an outside, a privacy can be protected.

Moreover, when optical device 1 is in the light reflection state, a light shielding property and a heat shielding property can be enhanced. Optical device 1 can be used also as a mirror.

### Advantageous Effects, Etc.

As described above, it is possible to switch among the light reflection state, the light transmission state, and the light scattering state of optical device 1 according to the present embodiment.

Now, as a device in which it is possible to switch between two states of the light reflection state and the light transmission state, PTL 1 discloses the light adjusting element, for example. On the other hand, there have conventionally been known devices in which it is possible to switch between two states of the light transmission state and the light scattering state. For example, in a polymer dispersed liquid crystal device, it is possible to switch between the light transmission state and the light scattering state by varying the refractive index of the liquid crystal.

Accordingly, combining these two kinds of devices may produce a device in which it is possible to switch among the light reflection state, the light transmission state, and the light scattering state. However, when a plurality of the devices are merely combined, the following problems arise.

For example, since loss of light transmittance occurs in each of the plurality of the devices, the light transmittance as a whole decreases. Thus, the transparency of the window declines.

Furthermore, since the plurality of the devices are produced individually, production costs increase. For example, the substrates, the electrodes and so on are needed for each device, resulting in an increased number of components. Moreover, the plurality of the devices are combined, resulting in an increased weight.

In contrast, optical device 1 according to the present embodiment includes first electrode 20 and second electrode 21 that have translucency and are disposed facing each other, and optical adjustment layer 30 that is disposed between first electrode 20 and second electrode 21. Optical adjustment layer 30 includes first phase 31 that includes an electrolyte including a metal having a visible light reflecting property, and second phase 32 that is dispersed in first phase 31, and includes a variable refractive index material having a refractive index that is variable in a visible light range.

This allows optical adjustment layer 30 to achieve the light reflection state, the light transmission state, and the light scattering state. For example, optical adjustment layer 30 turns into (i) the light reflection state when the metal included in the electrolyte is deposited on one of first electrode 20 and second electrode 21 to form metal film 33, (ii) the light transmission state when the metal included in the electrolyte does not form metal film 33 and the refractive index of first phase 31 and the refractive index of second phase 32 are substantially equal to each other, and (iii) the light scattering state when the metal included in the electrolyte does not form metal film 33 and the refractive index of first phase 31 and the refractive index of second phase 32 are different.

As described above, since a single device can achieve the three optical states, it is possible to suppress the decrease in transmittance and the increase in production costs and weight. That is to say, merely by providing a pair of electrodes (first electrode 20 and second electrode 21) and optical adjustment layer 30, the number of the components such as the electrodes can be reduced compared with the case of combining the plurality of the devices.

Now, when the three optical states are to be achieved by a single device, a simple configuration may be the one obtained by dissolving the electrolyte including the metal having the visible light reflecting property in a liquid crystal material having a variable refractive index. However, dissolving the electrolyte in the liquid crystal material is difficult because of the difference in dielectric constant. Furthermore, even if the electrolyte were dissolved, an electrically polarized liquid crystal and ionized metal ions (for example, silver ions) would cause an electrical interaction, thus preventing the metal ions from being deposited on the electrode. Consequently, the light reflection state cannot be achieved.

In contrast, in optical device 1 according to the present embodiment, for example, first phase 31 may further include a polymeric material and a high boiling point solvent. For example, the variable refractive index material may be a liquid crystal.

This makes it possible to dissolve the electrolyte in the polymeric material and the high boiling point solvent and disperse the liquid crystal material. Thus, the three optical states can be achieved. Furthermore, the use of the high boiling point solvent can suppress a decrease in reliability of optical device 1 owing to volatilization of a solvent due to a temperature increase during use.

Furthermore, for example, optical adjustment layer 30 may be gel.

This can suppress an outflow of optical adjustment layer 30 at a time of breakage of first substrate 10, second substrate 11, or sealing material 40.

Moreover, for example, the metal included in the electrolyte may be deposited on one of first electrode 20 and second electrode 21 when a DC voltage is applied across first electrode 20 and second electrode 21.

In this manner, by switching between application and non-application of the DC voltage, it is possible to switch between the light reflection state and the light transmission state or the light scattering state.

Additionally, for example, the refractive index of the variable refractive index material may be (i) substantially equal to the refractive index of first phase 31 when an AC voltage is applied across first electrode 20 and second electrode 21, and (ii) different from the refractive index of first phase 31 when no voltage is applied across first electrode 20 and second electrode 21.

In this manner, by switching between application and non-application of the AC voltage, it is possible to switch between the light transmission state and the light scattering state.

(Variation)

The embodiment described above has been directed to an example in which first phase 31 includes the high boiling point solvent. However, there is no particular limitation to this. First phase 31 may include an ionic liquid instead of the high boiling point solvent.

The ionic liquid can be, for example, an ammonium salt, an imidazolium salt, a pyrrolidinium salt or the like. Similarly to the case of including the high boiling point solvent, the ionic liquid has a boiling point of higher than or equal to 85° C. and preferably higher than or equal to 100° C. On the other hand, the ionic liquid has a melting point of, for example, lower than or equal to −20° C. Furthermore, the ionic liquid has a relative dielectric constant of greater than or equal to 30 and preferably greater than or equal to 40. Moreover, the ionic liquid may be of a material that is not oxidized or reduced easily during voltage application, in other words, a material having a wide potential window. At this time, the potential window is, for example, wider than or equal to ±1 V and preferably ±2 V.

More specifically, the ionic liquid can be 1-butyl-3-methylimidazolium hexafluorophosphate (BMIMPF6), 1-butyl-3-methylimidazolium bis(trifluoromethylsulfonyl) amide (BMImTFSI), 1-ethyl-3-methylimidazolium bis(trifluoromethylsulfonyl) imide (EMI-BTI), 1-butyl-1-methylpyrrolidinium bis(trifluoromethylsulfonyl) imide (BMP-BTI), 1-hexyl-3-methylimidazolium hexafluorophosphate (HMI-HFP), 1-methyl-3-octylimidazolium tetrafluoroborate (MOI-TFB) or the like. Alternatively, a plurality of these ionic liquids may be mixed together, or the high boiling point solvent may be added further.

### EXAMPLE

Now, the following is a description of an example of optical device 1 according to the present variation. The inventors prepared a sample according to the example of the present variation, and confirmed that this sample was able to achieve the three optical states described above.

First, the electrolyte was dissolved in the ionic liquid by adding the electrolyte to the ionic liquid, followed by stirring. As the ionic liquid, 10 mL of BMImTFSI (produced by Sigma-Aldrich Co. LLC.) was used. Furthermore, as the electrolyte, 85 mg of silver nitrate (special grade, produced by Wako Pure Chemical Industries, Ltd.) was used.

Next, a variable refractive index material was added to the ionic liquid in which the electrolyte had been dissolved. Then, a polymeric material and a cross-linking agent were added, followed by stirring. As the variable refractive index material, 2 mL of mlc-2169 produced by Merck Ltd. was used. As the polymeric material, 0.4 g of PDMAEMA (special grade, produced by Wako Pure Chemical Industries, Ltd.) was used. As the cross-linking agent, 0.5 g of C12TFSA (special grade, produced by Wako Pure Chemical Industries, Ltd.) was used. The stirring was performed at 80° C. for 30 minutes.

In this manner, a solution serving as a raw material of optical adjustment layer 30 according to the present variation was prepared. Incidentally, other steps such as a step of injecting this solution between first substrate 10 and second substrate 11 are similar to those in the example according to the above-described embodiment.

As described above, in optical device 1 according to the present variation, first phase 31 further includes the polymeric material and the ionic liquid, for example.

This makes it possible to dissolve the electrolyte in the polymeric material and the ionic liquid and disperse the liquid crystal material. Thus, the three optical states can be achieved. Additionally, the ionic liquid has a property of having substantially no vapor pressure and a wide temperature range. Accordingly, it is possible to suppress a decrease in reliability of optical device 1 owing to volatilization of the ionic liquid due to a temperature increase during use.

(Others)

In the above description, the optical device according to the present invention has been discussed based on the above-noted embodiment and variation thereof. However, the present invention is by no means limited to the embodiment above.

For example, the above-noted embodiment has illustrated an example in which the light reflection state is achieved when the DC voltage is applied, the light transmission state is achieved when the AC voltage is applied, and the light scattering state is achieved when no voltage is applied. However, there is no particular limitation to this. For example, in optical device 1, any one of the application of the AC voltage, the application of the DC voltage, and the application of no voltage may have one-to-one correspondence with any of the light reflection state, the light transmission state, and the light scattering state.

For example, the refractive index of first phase 31 and the refractive index of second phase 32 may be different when the AC voltage is applied, and the refractive index of first phase 31 and the refractive index of second phase 32 may be substantially equal to each other when no voltage is applied. In this manner, for example, optical device 1 may achieve the light scattering state when the AC voltage is applied, and optical device 1 may achieve the light transmission state when no voltage is applied. For example, according to a material of the liquid crystal included in second phase 32, the voltage to be applied and the optical state of optical device 1 can be adjusted appropriately.

Furthermore, for example, the embodiment described above has illustrated an example in which second phase 32 is dispersed in first phase 31. However, there is no particular limitation to this. For example, second phase 32 may be stacked on first phase 31. In this case, by changing the refractive index of the variable refractive index material included in second phase 32, it is possible to refract incident visible light toward a predetermined direction.

Moreover, for example, the embodiment described above has used the liquid crystal as the variable refractive index material. However, there is no particular limitation to this. The variable refractive index material may be any material as long as the refractive index with respect to the visible light can be varied according to the application of voltage.

It should be noted that, other than the above, a mode obtained by making various modifications conceivable by a person skilled in the art to each embodiment and a mode configured by any combination of the structural components and functions in each embodiment as long as not departing from the purport of the present invention fall within the scope of the present invention.

### REFERENCE MARKS IN THE DRAWINGS

1 Optical device
20 First electrode
21 Second electrode
30 Optical adjustment layer
31 First phase
32 Second phase
33 Metal film

1. An optical device comprising:
a first electrode and a second electrode that have translucency and are disposed facing each other, and
an optical adjustment layer that is disposed between the first electrode and the second electrode,
wherein the optical adjustment layer includes:
a first phase that includes an electrolyte including a metal having a visible light reflecting property; and
a second phase that is dispersed in the first phase, and includes a variable refractive index material having a refractive index that is variable in a visible light range.

2. The optical device according to claim 1,
wherein the first phase further includes a polymeric material and a high boiling point solvent.

3. The optical device according to claim 1,
wherein the first phase further includes a polymeric material and an ionic liquid.

4. The optical device according to claim 1,
wherein the optical adjustment layer is gel.

5. The optical device according to claim 1,
wherein the variable refractive index material is a liquid crystal.

6. The optical device according to claim 1,
wherein the optical adjustment layer turns into:
(i) a light reflection state when the metal included in the electrolyte is deposited on one of the first electrode and the second electrode to form a metal film;
(ii) a light transmission state when the metal included in the electrolyte does not form the metal film and a refractive index of the first phase and a refractive index of the second phase are substantially equal to each other; and
(iii) a light scattering state when the metal included in the electrolyte does not form the metal film and the refractive index of the first phase and the refractive index of the second phase are different from each other.

7. The optical device according to claim 6,
wherein the metal included in the electrolyte is deposited on one of the first electrode and the second electrode when a DC voltage is applied across the first electrode and the second electrode.

8. The optical device according to claim 6,
wherein the refractive index of the variable refractive index material is:
(i) substantially equal to the refractive index of the first phase when an AC voltage is applied across the first electrode and the second electrode; and
(ii) different from the refractive index of the first phase when no voltage is applied across the first electrode and the second electrode.
